(19) United States
(12) Patent Application Publication
(10) Pub. No.: US 2011/0288897 A1
(43) Pub. Date: Nov. 24, 2011

(54) METHOD OF AGENT ASSISTED RESPONSE TO SOCIAL MEDIA INTERACTIONS

(75) Inventors: George Erhart, Loveland, CO (US); Valentine C. Matula, Granville, OH (US); David Skiba, Golden, CO (US)

(73) Assignee: AVAYA INC., Basking Ridge, NJ (US)

(21) Appl. No.: 12/786,215

(22) Filed: May 24, 2010

(51) Int. Cl. G06Q 10/00; G06F 17/27; G06Q 50/00; G06Q 99/00; G06F 17/30; G06F 15/16

(52) U.S. Cl. 705/7.13; 707/667; 709/204; 704/9; 707/E17.005; 707/E17.044

(57) ABSTRACT

Methods and systems provided herein provide an enterprise with the ability to conduct quickly and consistently respond to social media work items and other work items. In particular, a collaboration tool is provided to agents which allows the agents to view historical responses of other agents that have been determined, by an automated agent, to be relevant to a newly received work item. The relevant historical responses can be used to service newly received work items as either a suggestion for responding or as a response template. Responses to work items are then archived with data which describes the nature of the response and the work item for which it was created.

### FIELD OF THE INVENTION

The present invention is generally directed toward contact centers and specifically directed toward operating a contact center configured to conduct social media interactions.

### BACKGROUND

Today businesses monitor social media interactions looking for actionable user posts. The business is looking for customer service and sales opportunities based on the interactions of a social media user. The typical process used consists of utilizing automated monitoring gateways to gather interactions matching specific query terms or subjects. Then agents manually route and respond to potentially interesting posts. Although some automation exists, it is only in the gathering area. The act of bringing the interactions into the contact center and responding to the posts is a highly manual process.

The problem with existing systems is that the agents operating individually are unable to utilize the collective knowledge of the contact center to assist with their social media responses. This creates an inconsistent system of response on the social media front.

### SUMMARY

It is with respect to the above issues and other problems that the embodiments presented herein were contemplated.

Embodiments of the present invention propose a method, system, and contact center where agent responses are monitored, tracked, analyzed and utilized to build suggestions to future agent responses. These mechanisms will provide more consistency to agent responses and help the responding agent craft appropriate messages that fit the information and emotional level of the customer post. These mechanisms also provide automation and suggestions where previously the agent was required to create unique messages every time, which is a time consuming task.

It is one aspect of the present invention to organize previous knowledge about social media history and interactions. Agents who were previously unable to learn or take advantage of responses from others are now able to leverage the collective knowledge of the contact center and its constituents (i.e., other agents). Where previous messages from various agents of a single enterprise may have been disjointed, the present disclosure allows for a unification of agent responses across a contact center.

It is another aspect of the present invention to provide a mechanism for increasing agent response time as compared to the prior art systems. Although it is important for social media responses to seem natural and unscripted, ensuring that agents provide a consistent message and that agents do not leave out key details is a useful aspect of any contact center communication.

It is another aspect of the present invention to provide agents with the tools to systematically gauge the emotion and proper response level of messages. By utilizing the tools suggested herein, agents are less likely to come across as too strong or not caring when they should be more apologetic or calm in the face of irate posts.

In accordance with at least some embodiments of the present invention, a social media gateway is provided. The gateway is responsible for gathering all social media interactions and bringing them into the contact center. This may be an internally developed gateway or make use of a third-party product. The gateway may also bring in the location information of a social media interaction, if available. The gateway is also responsible for outbound communication. Agent posts are sent through this central point. The gateway also brings in any additional information required for analysis, such as user post history, connectedness of the user, etc.

In accordance with at least some embodiments of the present invention, a classification and response database is provided. This database hosts the configuration information used to perform text processing classification on incoming and outgoing interactions. The database stores the response information, both templates and real-time response history. The templates are used to match classification to response information. Data on response options and emotion levels are included in the data structures stored in the database. The response history is also stored in the data structure stored in the database. As agents compose and send back responses, they are stored for future reference in the database.

In accordance with at least some embodiments of the present invention, enhanced agent interactions are made possible with the utilization of information stored in the classification and response database. In particular, an agent interface is provided which offers the agent various options and guidance during response composition. The agent interface contains dynamic information that includes options for response as well as context information about the current work item. Information includes: work item context with user information, current social media post, historical posts by user, and historical responses by enterprise; analysis information on the current social media post, classification, emotion level, and historical trend; and agent assisted response templates including pre-populated responses for editing, which may be pre-populated according to a target emotion level. Thus, multiple responses may be created, each having a similar message, but being conveyed slightly differently according to a target emotion level.

As social media interactions come into the contact center, they are analyzed and classified before being routed to an agent. Before delivery to an agent, the system will compose all the required components for the agent display. The work item is delivered to the agent with all available historical information (posts, friends, responses, etc.), analyzed information (classification, emotion, etc.), and response composition work area.

Finally, the work item is delivered to the agent. The agent then analyzes all the information available and works to compose a valid response. The agent will be able to select from previous responses from this classification, edit a system select response, and/or check the emotion level match of the composed response. Once the agent is finished, the response is stored in the response database as well as being sent to the social media web site through the gateway.

In accordance with at least some embodiments of the present invention, a method is provided that generally comprises:

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “stalking” means the process of determining a person is presently using a social media network and can be contacted on that social media network in real time.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the invention is considered to include a tangible storage medium and prior art-recognized equivalents and successor media, in which the software implementations of the present invention are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

### BRIEF DESCRIPTION OF THE DRAWINGS

The present disclosure is described in conjunction with the appended figures:

FIG. 1 is a block diagram of an embodiment of a communication system operable to interact with persons using social media networks;

FIG. 2A is a block diagram of an embodiment of a social media gateway;

FIG. 2B is a block diagram of an embodiment of a dialog system;

FIG. 3 is a block diagram of an embodiment of a dialog data structure;

FIG. 4 is a flow diagram of an embodiment of a process for responding to social media interactions;

FIG. 5 is a block diagram of an embodiment of a computing environment; and

FIG. 6 is a block diagram of an embodiment of a computing system.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

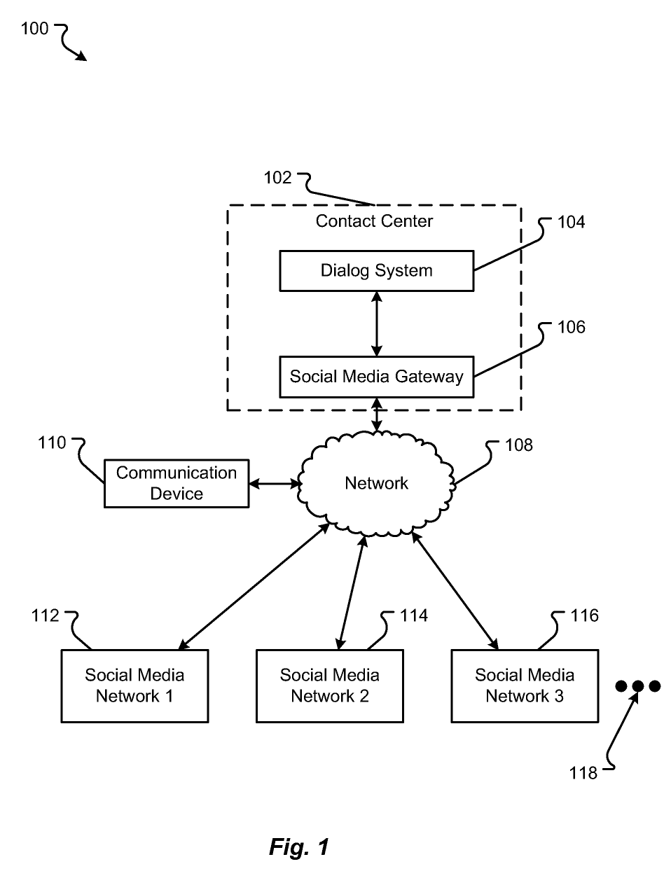

A communication system 100, for interacting with persons and conducting automated surveys using social media is shown in FIG. 1. The communication system 100 can include a contact center 102, a network 108, and one or more types of social media networks or systems, such as social media network 1 112, social media network 2 114, and social media network 3 116. Social media networks 1 112, 2 114, and/or 3 116 can be any social media including, but not limited to, networks, websites, or computer enabled systems. For example, a social media network may be MySpace, Facebook, Twitter, Linked-In, Spoke, or other similar computer enabled systems or websites. The communication system 100 can communicate with more or fewer social media networks 112, 114, and/or 116 than those shown FIG. 1, as represented by ellipses 118.

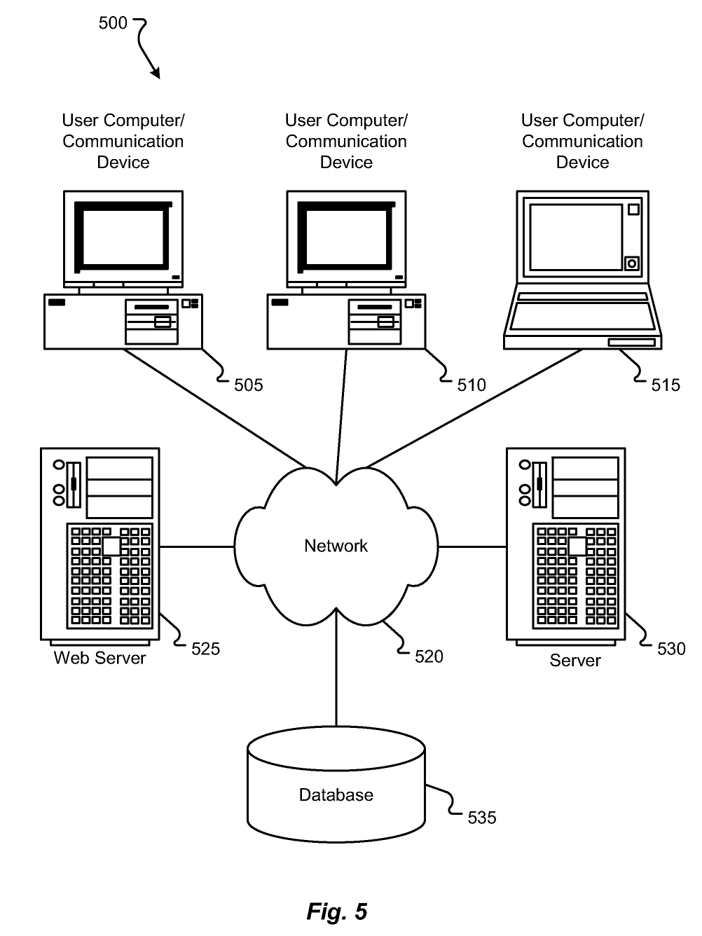

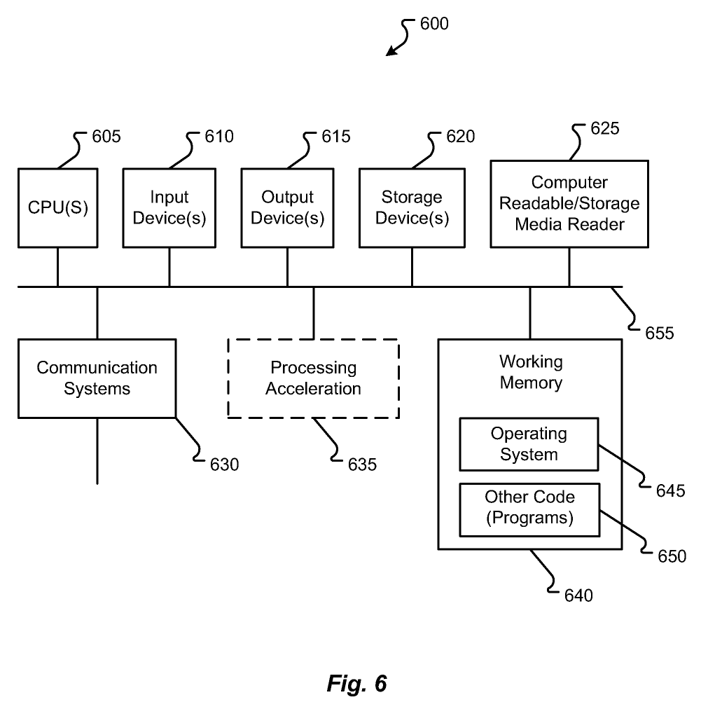

The network 108 can be any network or system operable to allow communication between the contact center 102 and the one or more social media networks 112, 114, and/or 116. The network 108 can represent any communication system, whether wired and/or wireless, using any protocol and/or format. One exemplary implementation of the network 108 is the Internet. The network 108 provides communication capability for the contact center 102 to communicate with sites (i.e., web-servers or server clusters via http formatted request and response protocols) corresponding to the one or more social media networks 112, 114, and/or 116. However, the network 108 can represent two or more networks, where each network is a different communication system using different communication protocols and/or formats and/or different hardware and software. For example, network 108 can be a wide area network, local area network, the Internet, a cellular telephone network, or some other type of communication system. The network may be as described in conjunction with FIGS. 5 and 6.

A contact center 102 can be a system owned and operated by an enterprise that can communicate with one or more persons that use social media networking sites. In some embodiments, the enterprise administering the contact center 102 may offer products and/or services to various customers. In some embodiments, the contact center 102 may be utilized to offer the products and/or services. In some embodiments, the contact center 102 may be utilized to provide customer support and related services for previously sold products and/or services. The contact center 102 can be hardware, software, or a combination of hardware and software. The contact center 102 can be executed by one or more servers or computer systems, as described in conjunction with FIGS. 5 and 6. The contact center 102 can include all systems, whether hardware or software, which allows the contact center 102 to receive, service, and respond to directed and automatically-retrieved contacts. For example the contact center 102 can include the telephone or email system, the interface to human agents, systems to allow human agents to service and respond to received contacts, and one or more systems operable to analyze and improve the function of agent interaction.

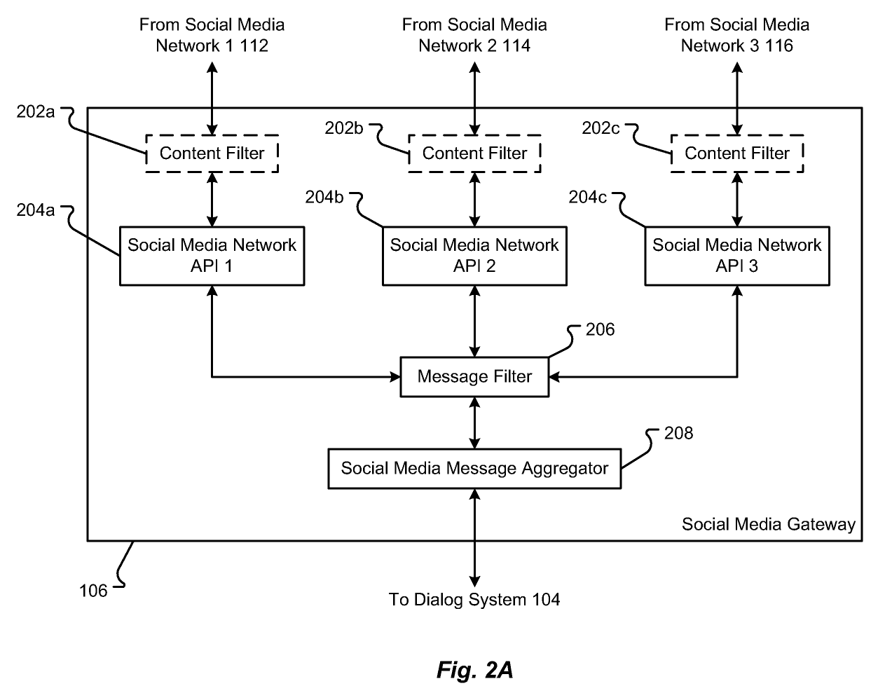

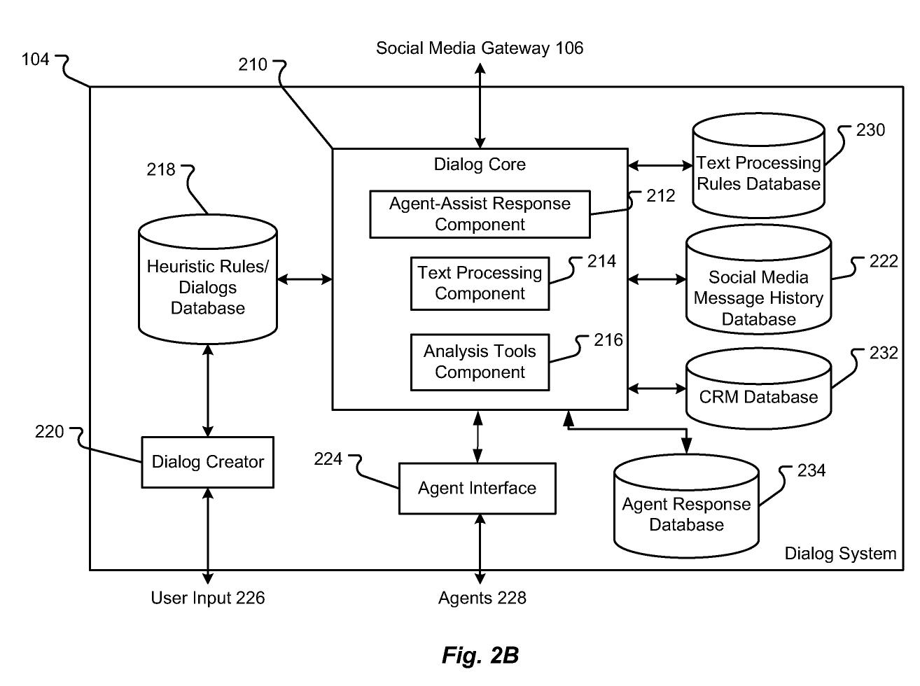

The contact center 102 may include a dialog system 104 and a social media gateway 106. While the dialog system 104 and the social media gateway 106 are shown as being a part of the contact system 102, in other embodiments, the dialog system 104 and/or the social media gateway 106 are separate systems or functions executed separately from the contact center 102 and/or executed by a third party. The dialog system 104 may process and receive messages. The social media gateway 106 can receive and translate messages from the one or more social media networks 112, 114, and/or 116. An embodiment of the dialog system 104 is described in conjunction with FIG. 2B. An embodiment of the social media gateway 106 is described in conjunction with FIG. 2A.

The contact center 102 may also communicate with one or more communication devices 110. The communication devices 110 can represent a customer's or user's cell phone, email system, personal digital assistant, laptop computer, or other device that allows the contact center 102 to interact with the customer. The contact center 102 can modify a non-direct contact, from a social media network 112, 114, and/or 116, into a directed contact by sending a response message directly to a customer's communication device 110.

An embodiment of the social media gateway 106 is shown in FIG. 2A. The social media gateway 106 can include one or more components which may include hardware, software, or combination of hardware and software. The social media gateway 106 can be executed by a computer system such as those in conjunction with FIGS. 5 and 6. However, in other embodiments, the components described in conjunction with FIG. 2A are logic circuits or other specially-designed hardware that are embodied in a field programmable gate array (FPGA).

Herein, the social media gateway 106 can include one or more content filters 202a, 202b, and/or 202c. A content filter 202 can receive all of the messages for the contact center 102 from a social media network 112, 114, and/or 116 and eliminate or delete those messages that do not require a response or relate to a particular customer survey. For example, a message between two friends on a Facebook page, if not pertaining to a product or a service of the company operating the contact center 102, may not need a response. As such, the content filter 202 can filter out or delete that non-suitable message from the messages that are received by social media network application programming interface (API) 1 204a, social media network API 2 204b, and/or social media network API 3 204c. With the content filter 202, the social media network API 204 only needs to translate those messages that should be received by the dialog system 104. Translation typically requires the conversion of the message into a different format.

The content filter 202 is provided with one or more heuristics for filter rules from a filter database (not shown). These filter rules can be created by the external customer or internal user (e.g. agent or administrator) of the communication system 100. Thus, the user or customer of the communication system 100 can customize the filtering of messages from social media networks 112, 114, and/or 116. Further, different rules may be applied to different social media networks, as some social media networks may have different types of messages or postings than other types of social media networks.

While the content filter 202 is shown as part of the social media gateway 106, it is to be appreciated that the content filter 202 may be a part of the social media network API 204. The content filter 202 may correspond to the query terms used by the social media network API 204. The content filter 202 or query terms are an argument to the social media network API 204 call. The social media network API 204 can be an application that the social media network 112, 114, and/or 116 provides to access the site. Thus, the social media network API 204 is called and connects the social media gateway 106 to the social media network 112, 114, and/or 116. Any suitable filter criteria may be employed. Examples include social media identifier (i.e., the known social media identifier of a customer of the enterprise that operates the contact center 102), content of source, address field, destination or recipient address fields, time stamp field, subject matter field, and message body field. For example, an obvious searchable content is the name of the business enterprise running the contact center 102 and/or products or services of the enterprises.

The social media gateway 106 can include one or more social media network API 204. As shown in FIG. 2A, the social media gateway 106 may include a social media network API 204 for each social media network 112, 114, and/or 116. As such, the social media gateway 106 can interact with each social media network 112, 114, and/or 116 in the particular (often unique) format or protocol used by the social media network 112, 114, and/or 116. Further, when new social media networks are created, the social media gateway 106 can easily be expanded to interact with those social media networks by adding another social media network API 204. Where social media networks 112, 114, and/or 116 are more standardized, or use substantially similar formats or protocols, a single social media network API can be shared by multiple such social media networks 112, 114, and/or 116.

The social media network API 204 can receive messages from and send messages corresponding to the social media network 112, 114, and/or 116. The social media network API 204 can translate a message received from a social media network 112, 114, and/or 116 and send the translated message to a message filter 206. The social media network API 204 can translate the received message into a standard formatted file. For example, the translated message may be represented by an extensible mark-up language (XML) file or other file having a general format. As such, each specific and particular social media network message can be translated into a standard format for use by the dialog system 104. Further, the social media network API 204 can receive a generally or standard format response message, from the dialog system 104 and translate that response into a particularly or specifically formatted response message that can be posted to the corresponding social media network 112, 114, and/or 116.

Messages to the contact center 102 are addressed to the contact center 102. For example, a customer may become a “friend” of the contact center 102 on a social media network 118, such as Facebook. The customer may then address a message to the contact center 102 on Facebook. This non-direct contact is a message that is not sent directly to the contact center 102 but to the contact center's Facebook page. In other embodiments, the contact center 102 receives messages not addressed to the contact center 102. For example, the contact center 102 can receive tweets from Twitter that are “broadcast” rather than addressed to the contact center 102. The contact center 102 may also search for message or content on the social media network 112, 114, and/or 116. Exemplary search criteria include customer name, customer profession, customer home address, customer business address, customer employer name, customer educational or professional background, customer hobby, personal or business interests, customer family profile, product name, service name, and the like. Thus, the social media gateway 106 of the contact center 102 can query, gather, or connect to a live feed of data from a social media network 112, 114, and/or 116 and then apply a filter to the indirect information.

The translated messages from the social media network API 204 can be received by a message filter 206. A message filter 206 can perform some or all of the functions of the content filter 202 and eliminate messages before being sent to the dialog system 104. However, in other embodiments, the message filter 206 eliminates information from within the messages before the trimmed messages are sent to the dialog system 104. For example, a message from a social media network 116 may have three or four interactions between two parties not associated with the contact center 102. Only one of the several postings may be pertinent to the dialog system 104. As such, the message filter 206 can eliminate or delete at least a portion of the other messages for the dialog system 104. Thus, the dialog system 104 receives a message where some of the content of the message has been deleted. The message filter 206 can retrieve heuristics or filter rules from a filter database (not shown), similar to the content filter 202. A substantial difference between the content and message filters 202 and 206 is that the content filter 202 is specific to a particular message format associated with a corresponding social media network 112, 114, and/or 116, while the message filter 206 is applied to a standardized or universal format and is therefore common to multiple social media networks 112, 114, and/or 116. One skilled in the art will understand the type of rules that may be used to filter information from messages such that only pertinent questions, facts, requests, or information is sent to the dialog system 104.

A message aggregator 208 may also be included with the social media gateway 106. A message aggregator 208 can, in contrast to the message filter 206, combine two or more messages into a packet or grouping that is sent to the dialog system 104. Therefore, the message aggregator 208 can inter-relate or combine messages based on different information within the messages. For example, two messages may be combined based on any of the message fields referenced above, such as the person that posted the message, the subject, the request or question asked, the person the message was sent to, or other information that may be pertinent to the dialog system 104. Thus, the dialog system 104 may be able to respond concurrently to two or more messages based on a grouping provided by the message aggregator 208. If the messages are aggregated or not aggregated, each message can be sent from the social media gateway 106 to the dialog system 104.

The social media gateway 106 can also send responses back to the social media networks 112, 114, and/or 116. A response from an agent in the contact center 102 can be sent to the social media gateway 106. The response may be in a general format and translated. The translated response may then be posted to the appropriate social media network 112, 114, and/or 116 by the social media gateway 106. In other embodiments, the agent may post the response directly to the social media network 112, 114, and/or 116 without sending the response to the social media gateway 106.

An embodiment of the dialog system 104 is shown in FIG. 2B. The dialog system 104 can include one or more components which may be hardware, software, or combination of hardware and software. The dialog system 104 can be executed by a computer system such as those described in conjunction with FIGS. 5 and 6. However, in other embodiments, the components described in conjunction with FIG. 2B, are logic circuits or other specially-designed hardware that are embodied in a field programmable gate array (FPGA) or application specific integrated circuit (ASIC). The components contained within the dialog system 104 can include a dialog core 210 that is communication with a message history database 222, an agent interface 224, and a heuristic rules and dialogs database 218. Further, the heuristic rules and dialogs database 218 can be in communication with a dialog creator 220.

The dialog core 210 can include one or more sub-components. For example, the dialog core 210 includes an agent-assist response component 212, a text processing component 214, and an analysis tools component 216. These components, similar to the components for the dialog system 104, can be hardware, software, or combination of hardware and software. The dialog core 210 steps through the states of a dialog data structure. A dialog is a set of inputs and associated actions that can be taken which allow for the automatic and structured response to social media requests or messages as well as the automatic and structured response to negative social media feedback. For example, if a user asks for a manual, the input of the text word “manual” can cause the dialog system 104 to send information about one or more manuals. In turn, the receiver of the response may respond, in kind, with the selection of a certain user manual. In which case, the dialog data structure may then automatically send the user to a website where the user can retrieve an electronic version of the manual. As such, the dialog data structure allows the dialog core 210 to automate the interaction between the contact center 102 and a person. This automation eliminates the need for agent involvement, in some situations, and makes the contact center 102 more efficient and more effective. Further, the automation expands the contact center's ability to answer numerous messages from the plethora of postings on the numerous social media networks 112, 114, and/or 116.

The dialog creator 220 will create a dialog data structure 300 that steps through various states for each social media message that comes into the contact center 102. The first step might be to send the social media message to the agent-assist response component 212, then to the text processing component 214, and then execute a query of a Customer Relationship Management (CRM) system and a CRM database 232 (to find out if this user has an existing order). A CRM database 232 can store information about customers or other data related to customer relations. Finally the dialog data structure might decide that the social media message should be sent to a human agent 228 for processing. The CRM database 232 may be the same or similar to the tracker database 110 in that the CRM database 232 can store information regarding customers of the contact center 102. The states or node transitions are in the dialog core 210 and make use of many different components that the dialog creator 220 combines in any way the user desires to handle the social media messages. The dialog core 210 can make use of the survey component 212, text processing component 214, or other systems. The dialog core 210 may also interface with a CRM system and/or CRM database 232, external databases, social media user information (e.g., followers, friends, post history, etc. from the social media site), or other systems.

The agent-assist response component 212 is operable to perform a number of functions on a received work item. In accordance with some embodiments, the agent-assist response component 212 is configured to first analyze a work item and classify the work item into one or more predetermined classification category. As an example, a work item may be classified based upon the type of product or service to which the comments in the work item pertain (i.e., classified based upon keyword, context, etc.) as well as a determined emotion level. Thus, two or more different attributes of the work item may be considered when classifying the work item into a predetermined classification category.

Based on the classification of the work item, the agent-assist response component 212 can then reference the agent response database 234 for other responses that have been previously generated by other agents of the contact center 102. The classification of the newly received work item is helpful to quickly identify pertinent historical responses from the agent response database 234. The agent-assist response component 212 then retrieves what it believes to be the most relevant and potentially useful responses from the agent response database 234 and scores the responses based on perceived relevance to the currently received work item. In scoring the historical responses, the agent-assist response component 212 applies a heuristic or rule set, which includes a number of variables for scoring responses for a work item. As can be appreciated, the scoring is performed for each newly received work item which is processed by the agent-assist response component 212. Moreover, the scores assigned to historical responses will likely vary each time the scoring computation is computed, primarily because the scoring is, each time, based on a unique work item received at the agent-assist response component 212. The variables which may be considered as part of the relevance determination include, without limitation, recency of response, language, keyword, channel type (i.e., social media website), media type (e.g., voice, video, text, images, audio, etc.), communication protocol used to post the social media content (e.g., http, https, SMS, MMS, etc.), agent responding, whether the historical responses have been marked as “useful” by other agents of the contact center, whether the historical responses have been identified as “popular” by virtue of the fact that it has been used for a response template more than a predetermined number of times, whether the historical responses have been identified as “ineffective” because the responses of customers thereto have been observed to be negative, skill level of the agent that constructed the historical response, and so forth.

As a simple example, a work item received at the agent-assist response component 212 may be classified as being related to a lost bag on a flight of a particular airline and the emotional level of the work item may be classified as “highly upset” based on the occurrence of particular keywords. The agent-assist response component 212 utilizes the classification of the work item to identify previous responses from the agent response database 234 which may be useful for responding to the newly received work item. The responses gathered from the agent response database 234 are scored based on relevancy to the newly received work item and then are organized according to the score assigned thereto.

Historical responses having the highest scores are then prepared by the agent-assist response component 212 for presentation to an agent along with the work item. In some embodiments, a predetermined number of the highest scoring historical responses are routed to an agent along with the newly received work item. In some embodiments, links to all of the relevant historical responses are routed to an agent along with the newly received work item. In some embodiments, the summaries of the highest scoring historical responses are prepared for presentation to an agent after they receive the work item. Other mechanisms of simultaneously presenting an agent with the newly received work item and the relevant historical responses retrieved from the agent response database 234 will become apparent to those skilled in the art and are within the scope of the present invention.

The text processing component 214 is operable to analyze text of one or more messages from social media networks 112, 114, and/or 116. Some possible methods for text processing can include Regular Expression, Latent Semantic Indexing (LSI), text part of speech tagging, text clustering, N-Gram document analysis, etc. In addition, for possibly longer documents, (such as, blogs or emails), the text processing component 214 may execute one or more methods of document summarization. The summarization may occur if the social media message will be sent to an agent 228 of the contact center 102; the summarization can reduce the amount of information that the agent may manage. The text processing rules or models may be stored in and/or retrieved from a text processing rules database 230. The text processing rules database 230 can be a database as described in conjunction with FIGS. 5 and 6 that stores rules or models used by the text processing component 214.

The text processing component 214 can be utilized by the agent-assist response component 212 to identify one or more occurrences of a particular text, such as using one or more of the message fields referenced above, in order to associate that social media message with one or more dialogs data structures in the heuristic rules and dialog database 218. For example, the text processing component can look for the word “manual,” in the social media message. If the word “manual” is found, the text processing component 214 may retrieve a dialog from the heuristic rules and dialogs database 218, which communicates with the customer about one or more owner's manuals, repair manuals, or other types of manuals. In another example, if the social media message includes the words, “buy”, “sell”, “price, “discount” or other types of words that may indicate the user or customer wishes to buy a product, the text processing component 214 can retrieve one or more dialogs from the heuristic rules and dialogs database 218 that can assist the customer in purchasing products or services from the enterprise.

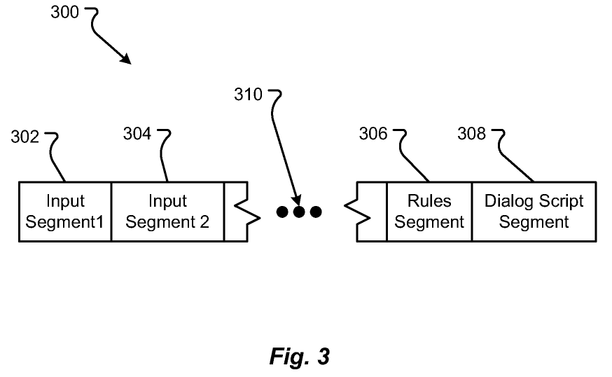

The analysis tools component 216 is operable to analyze response messages received back from an agent interface 224. In analyzing the agent's responses, the analysis tools component 216 can determine if the dialog data structures 300 (FIG. 3) originally retrieved by the text processing component 214 met the needs of the customer and to what extent the customer was satisfied with the response. The analysis tools component 216 may also be configured to determine whether a dialog data structure 300 generated in response to a poor customer feedback survey is sufficient for responding to the customer response. In the analysis, the agent may enter one or more items of information, for the analysis tools component 216, about the response and about how the response matched with the dialog data structures 300 and stored in the agent response database 234. The analysis tools component 216 can review the response and determine if it was similar to the response provided by the dialog data structure 300. Thus, the analysis tools component 216 can provide information to the dialog core 210 or the dialog creator 220 to improve the dialog data structures 300 (FIG. 3) that are included in the heuristic rules and dialogs database 218. Additionally, the analysis tools component 216 can maintain and organize data contained with the agent response database 234 to ensure that knowledge is efficiently disseminated throughout the contact center 102.

The message history database 222 can be any database or data storage system as described in conjunction with FIGS. 5 and 6. Likewise, the agent response database 234 can be any database or data storage system as described in conjunction with FIGS. 5 and 6. In some embodiments, the contents of the message history database 222 and the agent response database 234 are combined into a single database. Thus, the message history database 222 and/or agent response database 234 can store data in data fields, objects, or other data structures to allow other systems to retrieve that information at a later time. The message history database 222 can store previous messages or information about previous messages. The agent response database 234 can store previous messages or information about previous messages generated by agents of the contact center 102. Thus, for example, if the survey component 212 is analyzing several messages over a period of time, the survey component 212 can retrieve information about previous messages associated with the current survey from the message history database 222. As such, the agent-assist response component 212 can better identify relevant survey data from the social media networks 112, 114, and/or 116. The data stored by the message history database 222 can include the entire message or only a portion of the message, and in some circumstances, include metadata about the message(s).

The heuristic rules and dialogs database 218 can be any type of database or data storage system as described in conjunction with FIGS. 5 and 6. The heuristic rules and dialogs database 218 can store information and data fields, data objects, and/or any other data structures. An example of information stored within the heuristic rules and dialogs database 218 is described in conjunction with FIG. 3. The heuristic rules and dialogs database 218 stores rules and dialogs that automate responses to received social media messages. The dialogs control the interaction between the dialog core 210 and the social media network 112, 114, and/or 116. The dialogs or heuristic rules can be created by a dialog creator 220. Thus, the dialog creator 220 can interface with the user input 226 to receive information about dialogs. The user input 226 is then used to form the states and responses for a dialog.

An agent interface 224 is a communication system operable to send action items to contact center agents, in the contact center 102. An agent can be a person or other system that is operable to respond to certain questions or requests from a customer. For example, the agent can be a person that has specialized expertise in a topic area, such as technical support. The agent interface 224 can format the social message into an action item and forward that message to one or more agents 228. The agent interface 224 can also receive response(s) back from the agents 228. The information provided by the agent may be used by the dialog core 210 to complete a response to the social media message. For example, the information may classify the social media message (e.g., sales, service, etc.). In other embodiments, the response is a complete response to the social media message that can be posted to the social media network 112, 114, and/or 116.

An embodiment of a dialog data structure 300 is shown in FIG. 3. The dialog data structure 300 can be stored in several different forms of databases, such as relational databases, flat files, object-oriented databases, etc. Thus, while the term “data field” or “segment” is used, the data may be stored in an object, an attribute of an object, or some other form of data structure. Further, the dialog data structure 300 can be stored, retrieved, sent, or received during the processing of dialogs by the dialog core 210 or the dialog creator 220. The dialog data structure 300 stores one or more items of information in one or more data fields. The numeric identifiers (e.g. 302, 304, etc.) shown in FIG. 3 can identify, in one or more fields or segments, either the data field or segment or the data stored in the data field or segment.

The dialog data structure 300 can include one or more input segments, such as, input segment 1 302 and input segment 2 304, a rules segment 306, and/or a dialog script segment 308. Input segments 302 and 304 each include one or more fields comprising the one or more inputs that may be required to associate a social media message, a classification thereof, or an agent response thereto with the dialog data structure 300. The inputs segments 302 and 304 may include a customer identity, a respective customer type, a text word, a phrase, a product name, a service description, a customer's social media identifier, or other information that indicates that the dialog data structure 300 is associated with the social media messages. Alternatively, or in addition, the input segments 302 and 304 may include an agent identification, an agent skill level, a response popularity rating, a response classification, a response emotion level, or other information that indicates that the dialog data structure 300 is associated with a particular historical response. While there are only two input segments 1 302 and 2 304 shown in FIG. 3, there may be more or fewer input segments associated with the dialog data structure 300, as indicated by ellipses 310.

The rules segment 306 can include one or more heuristic rules that either help with the association of the respective dialog data structure 300 with the social media message or control the interaction between the dialog core 210 and the social media customer or between the dialog core 210 and the agents 228. For example, the rule 306 can state that the dialog data structure 300 applies only if the social media message includes input segment 1 302 but not input segment 2 304. One skilled in the art will be able to identify other types of rules that may govern the association of the dialog data structure 300 with the social media message. In other embodiments, the rules segment 306 states that if the social media message includes inputs 1 302 and/or 2 304, then the dialog core 210 should respond with a certain type of action.

Generally, a dialog script segment 308 includes a script of actions or responses that direct one or more other components, such as the dialog core 210 (FIG. 2B), to conduct the actions or send the responses. The dialog script segment 308 can include the one or more responses required by the dialog core 210. If the dialog script segment 308 applies (that is, if the social media message is requesting a certain type of information), the dialog script segment 308 may include the one or more responses that the dialog core 210 should communicate to respond to that social media message, include in survey results, or the like. Alternatively, or in addition, the dialog script segment 308 may include information for presenting sample responses to an agent when a work item is routed to the agent 228. The dialog script segment 308 can also include a response and a pointer to another dialog script segment 308 or another dialog data structure 300. Further, the dialog script segment 308 may have one or more actions that may be taken by another component after a secondary response is received by a customer or after a response is posted by an agent 228.

It should be noted that the dialog script segment 308 can reference one or more other dialog data structures 300. Thus, the dialog script segment 308 can direct the dialog core 210 to reference at least one other dialog data structure 300 to further act on the social media message or update customer survey results. Further, the social media message can be subject of two or more dialog script segments 308, and direct the dialog core 210 to complete two dialog script segments on the social media message. Also, dialog script segments 308 may not be associated with a response but direct the dialog core 210 to complete other actions, such as populating databases or gathering information.

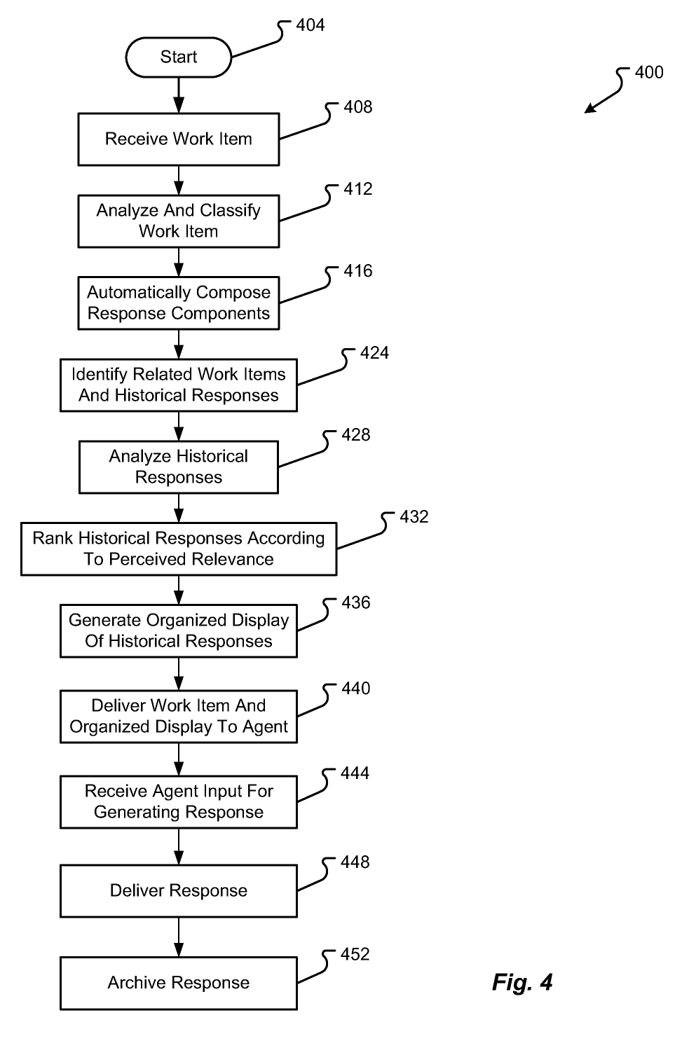

Referring now to FIG. 4, an exemplary method 400 of preparing a response to a social media work item will be described in accordance with at least some embodiments of the present invention. The method 400 begins (step 404) and proceeds when a work item is received at the contact center (step 408). The work item may correspond to a directed work item or a work item retrieved from a social media channel.

Thereafter, the method 400 continues with the agent-assist response component 212 analyzing the work item and classifying the work item based on the analysis thereof (step 416). In this step, the agent-assist response component 212 may utilize the text processing component 214 to analyze the content of the work item for the occurrence of certain keywords or keyphrases which help to classify the work item. The frequency of keyword or keyphrase occurrences may also help during the work item classification. A punctuation analysis may also contribute to the classification step. For example, utilization of more than a predetermined number of question marks may help to classify a work item emotion level as “confused” whereas utilization of more than a predetermined number of exclamation points may help classify a work item emotion level as “angry”, “excited”, “upset”, etc. Other factors which may be considered during the classification step include the source of the work item, the author of the work item (e.g., whether the author is a known customer of the enterprise operating the contact center 102), and whether the customer has recently received a particular product or service. The classification step may further include determining an emotion level associated with the content of the work item. Exemplary emotion levels include, without limitation, “pleased”, “displeased”, “upset”, “irate”, “belligerent”, “angry”, “neutral”, “confused”, “excited”, etc.

Based on the classification of the work item, the agent-assist response component 212 performs a database lookup at the agent response database 234 utilizing one or more classifications of the work item as a search query term (step 424). This results in the agent-assist response component 212 identifying one or more historical responses that are relevant or related to the newly received work item. The historical responses retrieved from the agent response database 234 are further analyzed (step 428) to determine a relative ranking of the historical responses according to perceived relevance to the newly received work item (step 432). In this step, the agent-assist response component 212 may first consider how well the historical response met the search terms. For example, a historical response having fourteen occurrences of a search term may be considered more relevant for ranking purposes as compared to a historical response only having one occurrence of a search term. Other factors may also be considered during the ranking step. For instance, the source of (i.e., agent whom constructed) the historical response may be a factor considered during the ranking step. A response that was constructed by an agent with a relatively high skill level may be assigned a higher ranking than a response that was constructed by an agent with a relatively lower skill level. Another factor which may be considered during the ranking step includes considering other agents' previous use of the response. For example, if a particular historical response has been used more frequently than another historical response, then the more frequently used response may be assigned a higher ranking as compared to other responses.

The historical responses are then organized according to their relative rankings and a display of the historical responses is prepared (step 436). In some embodiments, all historical responses which were identified as related in step 424 may be included in the display. In some embodiments, only a subset of all related historical responses may be included in the display, preferably having the higher ranking historical responses being displayed in favor of the lower ranking historical responses. In some embodiments, the display can be organized according to the relative ranking, meaning that the highest ranking historical responses can be displayed more prominently than other historical responses or at the top of a list containing other historical responses.

The agent-assist response component 212 then delivers the work item along with the organized display to an appropriate agent (step 440). In some embodiments, the work item is delivered simultaneous with the organized display. In some embodiments, the work item is delivered after the organized display is delivered to the agent. In some embodiments, the work item is delivered before the organized display is delivered to the agent.

The agent is then allowed to review the work item along with the organized display of the historical responses and craft a custom and personalized response to the work item (step 444). In this step the agent may utilize one or more of the historical responses as a template in generating the custom and personalized response. It may be possible that the agent utilizes the entirety of a historical response in generating the custom and personalized response. The historical response may be altered or used verbatim. A historical response which is used verbatim to respond to the newly received work item may be considered customer and personalized by virtue of the fact that the agent selected that historical response for use in the present situation without any further modifications. Of course, the agent may have the ability to alter the historical response to suit the present needs of the work item.

Thereafter, the response crafted by the agent is delivered back to the customer (step 448). In some embodiments, the response is delivered directly back to the customer (e.g., by sending the response directly to a communication device owned or operated by the customer). In some embodiments, the response is delivered back to the media channel from which the work item was obtained. For example, the response may be delivered as a response to a blog or social network comment made by the customer. In such an example, the response is transmitted back to the webserver serving the social media network and is posted by that webserver onto the social media site. A combination of the above delivery options can also be utilized.

Simultaneous, before, or after step 448, the response is also archived by the analysis tools component 216 into the agent response database 234 (step 452). Responses to work items are archived with data (i.e., in the data structure 300) which describes the nature of the response and the work item for which it was created (i.e., the classifications assigned to the work item). Subsequent customer responses to the first issued response may also be analyzed to further refine the qualification with which the initial response is archived. For example, if a response receives a positive customer response, then that response may be marked accordingly. This allows the response to be utilized as a historical response by other agents that service future work items. Not only does this provide a mechanism for quickly disseminating information throughout a contact center 102, but it also provides agents within the contact center 102 with an automated and simple way of collaborating about related work items and responses, regardless of whether or not the agents work in the same location. Moreover, it allows the contact center 102 to provide a systematic approach to responding to social media work items and other directed work items in a manner that has a personal touch, yet a certain level of consistency.

The method 400 may then either end or return back to step 404.

FIG. 5 illustrates a block diagram of a system 500 that may function as servers, computers, or other systems provided herein. The system 500 includes one or more user computers 505, 510, and 515. The user computers 505, 510, and 515 may be general purpose personal computers (including, merely by way of example, personal computers, and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 505, 510, 515 may also have any of a variety of applications, including for example, database client and/or server applications, and web browser applications. Alternatively, the user computers 505, 510, and 515 may be any other electronic device, such as a thin-client computer, Internet-enabled mobile telephone, and/or personal digital assistant, capable of communicating via a network 520 and/or displaying and navigating web pages or other types of electronic documents. Although the exemplary system 500 is shown with three user computers, any number of user computers may be supported.

System 500 further includes a network 520. The network 520 may can be any type of network familiar to those skilled in the art that can support data communications using any of a variety of commercially-available protocols, including without limitation SIP, TCP/IP, SNA, IPX, AppleTalk, and the like. Merely by way of example, the network 520 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 502.11 suite of protocols, the Bluetooth™ protocol known in the art, and/or any other wireless protocol); and/or any combination of these and/or other networks. The network 520 may be the same or similar to network 105.

The system may also include one or more server computers 525, 530. One server may be a web server 525, which may be used to process requests for web pages or other electronic documents from user computers 505, 510, and 520. The web server can be running an operating system including any of those discussed above, as well as any commercially-available server operating systems. The web server 525 can also run a variety of server applications, including SIP servers, HTTP servers, FTP servers, CGI servers, database servers, Java servers, and the like. In some instances, the web server 525 may publish operations available operations as one or more web services.

The system 500 may also include one or more file and or/application servers 530, which can, in addition to an operating system, include one or more applications accessible by a client running on one or more of the user computers 505, 510, 515. The server(s) 530 may be one or more general purpose computers capable of executing programs or scripts in response to the user computers 505, 510 and 515. As one example, the server may execute one or more web applications. The web application may be implemented as one or more scripts or programs written in any programming language, such as Java™, C, C#™, or C++, and/or any scripting language, such as Perl, Python, or TCL, as well as combinations of any programming/scripting languages. The application server(s) 530 may also include database servers, including without limitation those commercially available from Oracle, Microsoft, Sybase™, IBM™ and the like, which can process requests from database clients running on a user computer 505.

The web pages created by the web application server 530 may be forwarded to a user computer 505 via a web server 525. Similarly, the web server 525 may be able to receive web page requests, web services invocations, and/or input data from a user computer 705 and can forward the web page requests and/or input data to the web application server 730. In further embodiments, the server 530 may function as a file server. Although for ease of description, FIG. 5 illustrates a separate web server 525 and file/application server 530, those skilled in the art will recognize that the functions described with respect to servers 525, 530 may be performed by a single server and/or a plurality of specialized servers, depending on implementation-specific needs and parameters. The computer systems 505, 510, and 515, file server 525 and/or application server 530 may function as the system, devices, or components described in FIGS. 1-3.

The system 500 may also include a database 535. The database 535 may reside in a variety of locations. By way of example, database 535 may reside on a storage medium local to (and/or resident in) one or more of the computers 505, 510, 515, 525, 530. Alternatively, it may be remote from any or all of the computers 505, 510, 515, 525, 530, and in communication (e.g., via the network 520) with one or more of these. In a particular set of embodiments, the database 535 may reside in a storage-area network (“SAN”) familiar to those skilled in the art. Similarly, any necessary files for performing the functions attributed to the computers 505, 510, 515, 525, 530 may be stored locally on the respective computer and/or remotely, as appropriate. In one set of embodiments, the database 535 may be a relational database, such as Oracle 10i™, that is adapted to store, update, and retrieve data in response to SQL-formatted commands.

FIG. 6 illustrates one embodiment of a computer system 600 upon which the servers, computers, or other systems or components described herein may be deployed or executed. The computer system 600 is shown comprising hardware elements that may be electrically coupled via a bus 655. The hardware elements may include one or more central processing units (CPUs) 605; one or more input devices 610 (e.g., a mouse, a keyboard, etc.); and one or more output devices 615 (e.g., a display device, a printer, etc.). The computer system 600 may also include one or more storage devices 620. By way of example, storage device(s) 620 may be disk drives, optical storage devices, solid-state storage devices such as a random access memory (“RAM”) and/or a read-only memory (“ROM”), which can be programmable, flash-updateable and/or the like.

The computer system 600 may additionally include a computer-readable storage media reader 625; a communications system 630 (e.g., a modem, a network card (wireless or wired), an infra-red communication device, etc.); and working memory 640, which may include RAM and ROM devices as described above. In some embodiments, the computer system 600 may also include a processing acceleration unit 635, which can include a DSP, a special-purpose processor, and/or the like.

The computer-readable storage media reader 625 can further be connected to a computer-readable storage medium, together (and, optionally, in combination with storage device(s) 620) comprehensively representing remote, local, fixed, and/or removable storage devices plus storage media for temporarily and/or more permanently containing computer-readable information. The communications system 630 may permit data to be exchanged with the network 620 and/or any other computer described above with respect to the system 600. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 600 may also comprise software elements, shown as being currently located within a working memory 640, including an operating system 645 and/or other code 650, such as program code implementing the application server 530. It should be appreciated that alternate embodiments of a computer system 600 may have numerous variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the invention have been described in detail herein, it is to be understood that the inventive concepts may be otherwise variously embodied and employed, and that the appended claims are intended to be construed to include such variations, except as limited by the prior art.

What is claimed is:

1. A method, comprising:
receiving a work item in a contact center;
analyzing the work item;
based on the analysis of the work item, classifying the work item as being related to one or more predetermined work item classifications;
identifying historical agent responses that are also related to the one or more predetermined work item classifications; and
delivering the identified historical agent responses along with the work item to a contact center agent such that the contact center agent can leverage the identified historical agent responses when responding to the work item.

2. The method of claim 1, wherein the work item was retrieved from a social media channel and wherein the identified historical agent responses comprise responses to other work items retrieved from social media channels.

3. The method of claim 1, wherein the one or more predetermined work item classifications include at least one of a product classification, a service classification, and an emotion level classification.

4. The method of claim 2, wherein the one or more predetermined work item classifications include at least the emotion level classification and wherein the emotion level classification represent an estimated emotion level of a customer that created content of the work item, wherein the emotion level classification is determined, at least in part, based on an analysis of the work item for one or more of keyword, keyphrase, and punctuation.

5. The method of claim 4, wherein the identified historical agent responses comprise a similar emotion level classification as the work item.

6. The method of claim 1, further comprising:
ranking the identified historical agent responses according to perceived relevance to the work item;
organizing a display of the identified historical agent responses according to a relative ranking assigned to each identified historical agent response; and
presenting the organized display to the agent simultaneous with delivering the work item to the agent.

7. The method of claim 6, wherein the ranking is based on one or more of recency of historical response, language, keyword, channel type, media type, communication protocol, agent responding, whether the historical responses have been marked as useful, whether the historical responses have been identified as popular, whether the historical responses have been identified as ineffective, and skill level of the agent that constructed the historical response.

8. The method of claim 1, wherein the agent utilizes one or more of the identified historical agent responses as a template for creating a response to the work item.

9. The method of claim 8, wherein the one or more of the identified historical agent responses utilized as a template is identified as popular by virtue of the fact that the agent utilized the one or more of the identified historical agent responses.

10. The method of claim 9, further comprising:
delivering the agent response to a source of the work item; and
archiving the agent response in an agent response database, wherein the agent response is archived in the agent response database along with an indication of the one or more predetermined work item classifications and an identification of the one or more identified historical agent responses which were utilized as the template.

11. A computer readable medium having stored thereon instructions that cause a computing system to execute a method for responding to a work item, the instructions comprising:
instructions configured to analyze a work item received in a contact center;
instructions configured to classify the work item as being related to one or more predetermined work item classifications;
instructions configured to identify historical agent responses that are also related to the one or more predetermined work item classifications; and
instructions configured to deliver the identified historical agent responses along with the work item to a contact center agent such that the contact center agent can leverage the identified historical agent responses when responding to the work item.

12. The method of claim 11, wherein a source of the work item is a social media channel and wherein the identified historical agent responses comprise responses to other work items retrieved from social media channels.

13. The method of claim 12, wherein the one or more predetermined work item classifications include at least one of a product classification, a service classification, and an emotion level classification.

14. The method of claim 11, wherein the instructions further comprise:
instructions configured to rank the identified historical agent responses according to perceived relevance to the work item, wherein the ranking is based on one or more of recency of historical response, language, keyword, channel type, media type, communication protocol, agent responding, whether the historical responses have been marked as useful, whether the historical responses have been identified as popular, whether the historical responses have been identified as ineffective, and skill level of the agent that constructed the historical response;
instructions configured to organize a display of the identified historical agent responses according to a relative ranking assigned to each identified historical agent response; and
instructions configured to present the organized display to the agent along with delivering the work item to the agent.

15. The method of claim 11, wherein the instructions further comprise:
instructions configured to archive an agent response to the work item, wherein the agent response is archived along with an indication of the one or more predetermined work item classifications and one or more of (i) an identification of and (ii) link to one or more identified historical agent responses which were leveraged by the agent in crafting the response to the work item.

16. A communication system comprising:
a social media gateway; and
a dialog core including an agent-assist response component and a text processing component, the text processing component configured to analyze a work item received in a contact center and the agent-assist response component configured to classify the work item as being related to one or more predetermined work item classifications based on the analysis of the work item, wherein the agent-assist response component is further configured to identify historical agent responses that are also related to the one or more predetermined work item classifications and deliver the identified historical agent responses along with the work item to a contact center agent such that the contact center agent can leverage the identified historical agent responses when responding to the work item.

17. The communication system of claim 16, wherein a source of the work item is a social media channel and wherein the identified historical agent responses comprise responses to other work items retrieved from social media channels.

18. The communication system of claim 16, wherein the one or more predetermined work item classifications include at least one of a product classification, a service classification, and an emotion level classification.

19. The communication system of claim 16, wherein the agent-assist response component is further configured to rank the identified historical agent responses according to perceived relevance to the work item, wherein the ranking is based on one or more of recency of historical response, language, keyword, channel type, media type, communication protocol, agent responding, whether the historical responses have been marked as useful, whether the historical responses have been identified as popular, whether the historical responses have been identified as ineffective, and skill level of the agent that constructed the historical response, and wherein the agent-assist response component is further configured to organize a display of the identified historical agent responses according to a relative ranking assigned to each identified historical agent response and present the organized display to the agent along with delivering the work item to the agent.

20. The communication system of claim 16, wherein the dialog core further comprises an analysis tools component configured to analyze an agent response to the work item and archive the agent response to the work item, wherein the agent response is archived along with an indication of the one or more predetermined work item classifications and one or more of (i) an identification of and (ii) link to one or more identified historical agent responses which were leveraged by the agent in crafting the response to the work item.
